(19) United States
(12) Patent Application Publication
(10) Pub. No.: US 2024/0194903 A1
(43) Pub. Date: Jun. 13, 2024

(54) FUEL SUPPLY CONTROL APPARATUS OF ELECTROCHEMICAL CELL

(71) Applicants: HYUNDAI MOTOR COMPANY, Seoul (KR); KIA CORPORATION, Seoul (KR); H-CUBE SOLUTIONS, Seoul (KR)

(72) Inventors: In Chang Chu, Seoul (KR); Jong Sup Hong, Seoul (KR); Jang Hyun Lim, Seoul (KR); Woo Seok Lee, Seoul (KR); Joon Hoon Cho, Seoul (KR)

(21) Appl. No.: 18/197,872

(22) Filed: May 16, 2023

(30) Foreign Application Priority Data
Dec. 12, 2022 (KR) 10-2022-0172920

(51) Int. Cl. H01M 8/026; H01M 8/0247; H01M 8/04089; H01M 8/2475

(52) U.S. Cl. CPC H01M 8/026; H01M 8/0247; H01M 8/04089; H01M 8/2475

(57) ABSTRACT

A fuel supply control apparatus of an electrochemical cell uniformly distributes fuel supplied to the electrochemical cell. The fuel supply control apparatus includes a separator configured to have a fuel inlet, a fuel outlet, and a plurality of fuel channels arranged between the fuel inlet and the fuel outlet, and a fuel supply control plate stacked between the separator and a solid oxide cell and configured to uniformly distribute and supply fuel, flowing into the fuel channels, to the solid oxide cell, and the fuel supply control plate has a plurality of slits configured to extend in a direction orthogonal to the fuel channels and to be arranged in a length direction of the fuel channels.

### CROSS REFERENCE TO RELATED APPLICATIONS

This application claims under 35 U.S.C. § 119(a) the benefit of priority to Korean Patent Application No. 10-2022-0172920 filed on Dec. 12, 2022, the entire contents of which are incorporated herein by reference.

### BACKGROUND

### (a) Technical Field

The present disclosure relates to a fuel supply control apparatus of an electrochemical cell. More particularly, it relates to a fuel supply control apparatus of an electrochemical cell which uniformly distributes fuel supplied to the electrochemical cell.

### (b) Background Art

A water electrolysis system using solid oxide cells is an apparatus which decomposes water into hydrogen and oxygen using electrochemical reactions, and is being spotlighted as a next generation apparatus which may secure clean hydrogen due to advantages, such as high efficiency, high purity of generated hydrogen, high explosion stability, etc.

Further, when power supplied to the water electrolysis system so as to cause the electrochemical reactions is replaced with eco-friendly new and renewable energy (for example, solar energy, wind energy, or the like), hydrogen may be produced using surplus electric power without any environmental pollution, and thus, utilization of the new and renewable energy may be maximized.

In general, the water electrolysis system using solid oxide cells uses a water electrolysis stack assembled by stacking a plurality of unit cells in order to satisfy demanded hydrogen production.

The unit cell (referred to hereinafter as a “water electrolysis cell”) of the water electrolysis stack has a solid oxide cell including an electrolyte membrane through which oxygen ions migrate, and a fuel electrode and an air electrode provided on both surfaces of the electrolyte membrane by sintering.

Electrochemical reactions in the water electrolysis cell occur at reaction interfaces of the fuel electrode and the air electrode, and electrons are supplied to fuel (i.e., steam), supplied to the fuel electrode, through an external circuit and a power supply device. The steam is electrically decomposed into oxygen ions and hydrogen, thus producing hydrogen. The oxygen ions migrate to the air electrode through the electrolyte membrane, and are discharged as oxygen.

Further, separators are stacked on the upper and lower surfaces of the solid oxide cell, and the fuel is supplied to the solid oxide cell through fuel channels formed on the separators.

However, in the conventional water electrolysis cell, since reactivity at the fuel channels at the upstream part of the water electrolysis cell is higher than reactivity at the fuel channels at the downstream part of the water electrolysis cell, most of the electrochemical reactions are concentrated upon an inlet for the fuel channels, and thereby, stability of the water electrolysis cell is reduced and thus causes deterioration of the water electrolysis cell.

The above information disclosed in this Background section is only for enhancement of understanding of the background of the disclosure and therefore may contain information that does not form the prior art that is already known in this country to a person of ordinary skill in the art.

### SUMMARY

The present disclosure has been made in an effort to solve the above-described problems associated with the prior art, and it is an object of the present disclosure to provide a fuel supply control apparatus of an electrochemical cell, which may uniformly distribute fuel supplied to a solid oxide cell of the electrochemical cell.

In one aspect, the present disclosure provides a fuel supply control apparatus of an electrochemical cell including a solid oxide cell and a separator stacked on the solid oxide cell, the fuel supply control apparatus including the separator configured to have a fuel inlet, a fuel outlet, and a plurality of fuel channels arranged between the fuel inlet and the fuel outlet, and a fuel supply control plate stacked between the separator and the solid oxide cell and configured to uniformly distribute and supply fuel, flowing into the fuel channels, to the solid oxide cell, wherein the fuel supply control plate has a plurality of slits configured to extend in a direction orthogonal to the fuel channels and to be arranged in a length direction of the fuel channels.

In an exemplary embodiment, the plurality of slits may be configured such that slits located relatively close to the fuel inlet have a smaller width than slits located relatively far from the fuel inlet. Here, at least two of the plurality of slits may have different widths.

In another exemplary embodiment, distances between the plurality of slits may be gradually decreased in a direction from the fuel inlet to the fuel outlet. Here, at least two of the distances between the plurality of slits may be different. The distances between the plurality of slits may be distances between slits closest to each other among the plurality of slits.

In still another exemplary embodiment, the plurality of slits may extend in an arrangement direction of the fuel channels, and may extend to positions facing fuel channels disposed at the outermost positions among the fuel channels. Here, the slits may have an equal length.

In yet another exemplary embodiment, the fuel channels may be arranged in a row between the fuel inlet and the fuel outlet, and may extend in a direction orthogonal to a length direction of the fuel inlet and the fuel outlet.

In another aspect, the present disclosure provides a fuel supply control apparatus of an electrochemical cell including a solid oxide cell and a separator stacked on the solid oxide cell, the fuel supply control apparatus including the separator configured to have a fuel inlet, a fuel outlet, and a plurality of fuel channels arranged between the fuel inlet and the fuel outlet, and a fuel supply control plate configured to have a plurality of slits arranged in a length direction of the fuel channels, and stacked between the separator and the solid oxide cell, wherein the plurality of slits is configured such that slits located relatively close to the fuel inlet have a smaller width than slits located relatively far from the fuel inlet.

Other aspects and exemplary embodiments of the disclosure are discussed infra.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is an exploded perspective view showing a fuel supply control apparatus of an electrochemical cell according to one embodiment of the present disclosure;

FIG. 2 is an assembled perspective view showing the fuel supply control apparatus according to one embodiment of the present disclosure;

FIG. 3 is a plan view showing the fuel supply control apparatus according to one embodiment of the present disclosure;

FIG. 4 is a longitudinal-sectional view taken along line A-A of FIG. 3;

FIG. 5 is a plan view of a separator according to one embodiment of the present disclosure;

FIG. 6 is a plan view of a fuel supply control plate according to one embodiment of the present disclosure;

FIG. 7A is a longitudinal-sectional view illustrating the state in which fuel is supplied to a general electrochemical cell, to which the fuel supply control plate according to one embodiment of the present disclosure is not applied;

FIG. 7B is a longitudinal-sectional view illustrating the state in which fuel is supplied to an electrochemical cell, to which the fuel supply control plate according to one embodiment of the present disclosure is applied; and

FIG. 8 is a longitudinal-sectional view showing the electrochemical cell, to which the fuel supply control plate according to one embodiment of the present disclosure is applied.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Specific structural or functional descriptions in embodiments of the present disclosure set forth in the description which follows will be exemplarily given to describe the embodiments of the present disclosure, and the present disclosure may be embodied in many alternative forms.

In the following description of the embodiments, it will be understood that, when a part “comprises” or “includes” an element, the part does not exclude other elements, and may further include other elements, unless the context clearly indicates otherwise.

Further, in the following description of the embodiments, terms, such as “first” and “second”, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

The present disclosure induces uniform electrochemical reactions in all active reaction sites of the solid oxide cell of an electrochemical cell by uniformly controlling the amount of fuel supplied to the solid oxide cell, and thereby, reduces reaction deviations among the active reaction sites of the solid oxide cell and secures stability and performance of the electrochemical cell.

Hereinafter, embodiments of the present disclosure will be described with reference to the accompanying drawings. Matters expressed in the drawings are schematized to easily explain the embodiments of the present disclosure, and may be different from forms actually implemented.

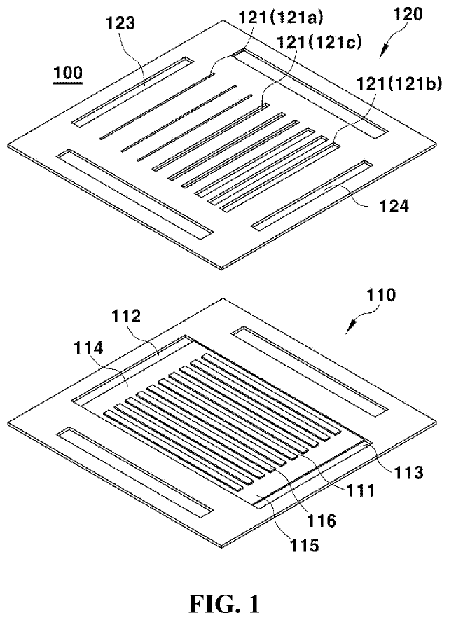

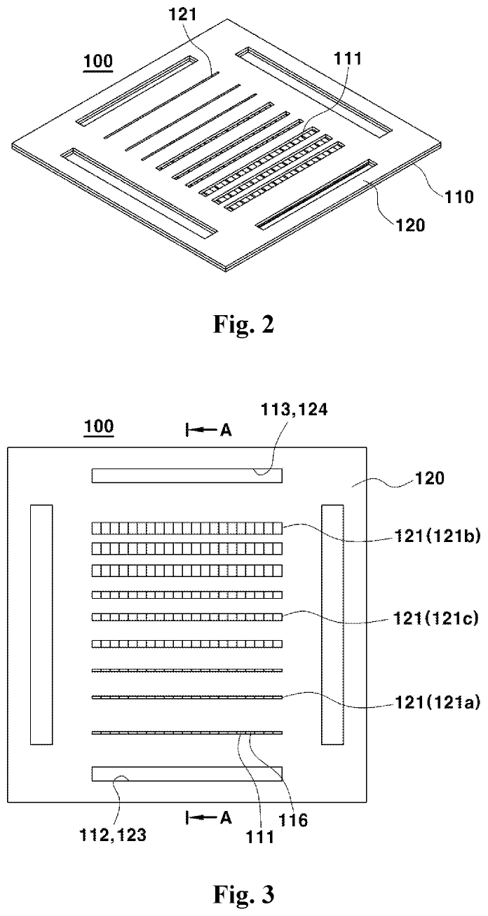

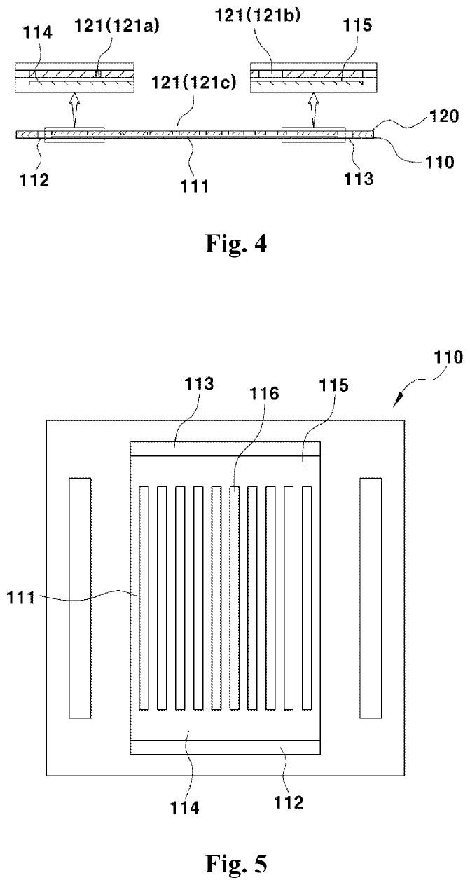

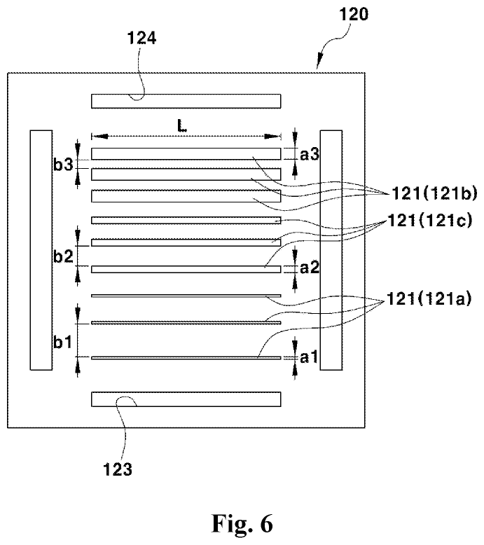

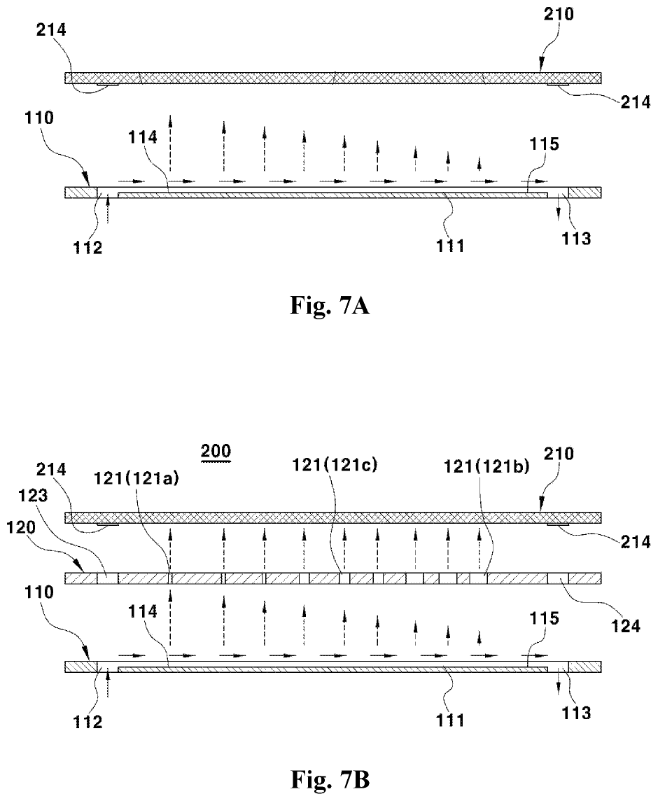

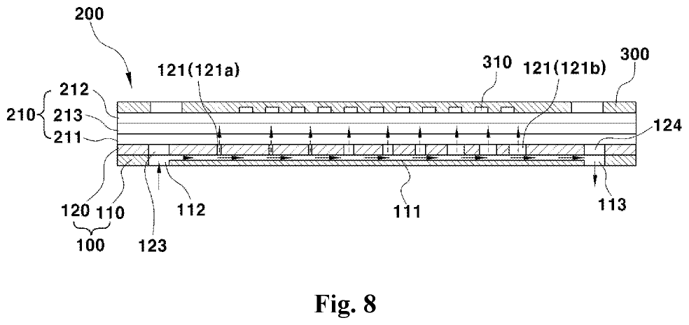

FIG. 1 is an exploded perspective view showing a fuel supply control apparatus of an electrochemical cell according to one embodiment of the present disclosure, FIG. 2 is an assembled perspective view showing the fuel supply control apparatus according to one embodiment of the present disclosure, FIG. 3 is a plan view showing the fuel supply control apparatus according to one embodiment of the present disclosure, FIG. 4 is a longitudinal-sectional view taken along line A-A of FIG. 3, FIG. 5 is a plan view of a separator according to one embodiment of the present disclosure, FIG. 6 is a plan view of a fuel supply control plate according to one embodiment of the present disclosure, FIG. 7A is a longitudinal-sectional view illustrating the state in which fuel is supplied to a general electrochemical cell, to which the fuel supply control plate according to one embodiment of the present disclosure is not applied, FIG. 7B is a longitudinal-sectional view illustrating the state in which fuel is supplied to an electrochemical cell, to which the fuel supply control plate according to one embodiment of the present disclosure is applied, and FIG. 8 is a longitudinal-sectional view showing the electrochemical cell, to which the fuel supply control plate according to one embodiment of the present disclosure is applied.

The fuel supply control apparatus according to one embodiment of the present disclosure is configured to uniformly control the flow rate of fuel supplied to the solid oxide cell of the electrochemical cell. The electrochemical cell may be a unit cell (i.e., a water electrolysis cell) of a water electrolysis stack. The water electrolysis cell may use steam as the fuel, or may use a mixture of steam and hydrogen as the fuel.

As shown in FIGS. 1 to 4, the fuel supply control apparatus 100 includes a separator 110, and a fuel supply control plate 120 stacked on one surface of the separator 110.

The separator 110 is formed as a flat plate having a designated thickness, and is stacked on one surface of a solid oxide cell 210 (with reference to FIG. 8).

As shown in FIGS. 1 and 5, a plurality of fuel channels 111 is provided on one surface of the separator 110. Here, the surface of the separator 110 is an inner surface of the separator 110 which faces a solid oxide cell 210. That is, the fuel channels 111 are formed on the inner surface of the separator 110.

The fuel channels 111 are formed in a depressed shape on the inner surface of the separator 110. The fuel channels 111 are formed to have designated length, width, and depth. The fuel channels 111 are arranged in a row to be spaced apart from one another by a designated distance.

In this embodiment, the fuel channels 111 may be arranged at equal intervals and may be formed to have the same width, but the structure of the fuel channels 111 is not limited thereby. Further, the fuel channels 111 may be arranged in parallel, and may have the same length.

Channel ribs 116 are respectively provided between the fuel channels 111. The channel ribs 116 may be formed to have the same width, but the structure of the channel ribs 116 is not limited thereby. The channel ribs 116 are pressed against the surface of the fuel supply control plate 120 facing the separator 110 when the fuel supply control plate 120 is stacked on the separator 110.

The fuel channels 111 are disposed between a fuel inlet 112 and a fuel outlet 113. That is, the separator 110 has the fuel inlet 112 and the fuel outlet 113 disposed at both sides of the fuel channels 111. The fuel channels 111 extend in a direction orthogonal to the length direction of the fuel inlet 112 and the fuel outlet 113. The fuel inlet 112 and the fuel outlet 113 are disposed at both sides of the fuel channels 111 in the length direction thereof.

An inlet-side step plane part (i.e., a first step plane part) 114 is provided between the fuel inlet 112 and the fuel channels 111. Further, an outlet-side step plane part (i.e., a second step plane part) 115 is provided between the fuel outlet 113 and the fuel channels 111.

The respective step plane parts 114 and 115 are formed on the inner surface of the separator 110. The step plane parts 114 and 115 may be formed in a depressed shape on the inner surface of the separator 110. The step plane parts 114 and 115 may be depressed to the same depth as the fuel channels 111.

The fuel inlet 112 is formed adjacent to ends of the fuel channels 111 through the first step plane part 114. The fuel outlet 113 is formed adjacent to the other ends of the fuel channels 111 through the second step plane part 115.

The fuel inlet 112 and the fuel outlet 113 are disposed to face each other across the fuel channels 111. The fuel inlet 112 and the fuel outlet 113 are formed as openings having a designated length and width. The fuel inlet 112 and the fuel outlet 113 may be symmetrical to each other with respect to the fuel channels 111.

The fuel inlet 112 and the fuel outlet 113 extend in the arrangement direction of the fuel channels 111. The fuel inlet 112 and the fuel outlet 113 extend to the fuel channels 111, which are disposed at the outermost positions, among the fuel channels 111. The fuel inlet 112 and the fuel outlet 113 extend in a direction orthogonal to the fuel channels 111.

Fuel supplied to the fuel inlet 112 flows into the fuel channels 111 through the first step plane part 114 (with reference to arrows indicated by a solid line in FIGS. 7A and 7B). Here, the fuel flowing into the fuel channels 111 is supplied to the solid oxide cell 210 through the fuel supply control plate 120 while passing through the fuel channels 111. Here, a part of the fuel, which is not supplied to the solid oxide cell 210, is discharged through the fuel outlet 113.

The fuel supply control plate 120 is stacked on the inner surface of the separator 110 having the above-described configuration. The fuel supply control plate 120 is configured to uniformly disperse and transmit the fuel, flowing while passing through the fuel channels 111, to all active reaction sites of the solid oxide cell 210.

As shown in FIGS. 1 and 6, the fuel supply control plate 120 is formed as a flat plate having a designated thickness, and is stacked on the inner surface of the separator 110. The fuel supply control plate 120 has a plurality of slits 121 so as to control the flow rate of the fuel supplied to the solid oxide cell 210.

The slits 121 may be formed in the fuel supply control plate 120 through a computer numerical control (CNC) process, a punching process, a laser process, an etching process, etc.

The slits 121 are formed through the fuel supply control plate 120 in the thickness direction thereof. Here, the respective slits 121 are formed as rectilinear openings having a designated length and width. The respective slits 121 extend in the arrangement direction of the fuel channels 111. That is, the respective slits 121 extend in a direction orthogonal to the fuel channels 111. Further, the respective slits 121 extend to positions facing the fuel channels 111, which are disposed at the outermost positions, among the fuel channels 111. The slits 121 may have the same length L.

Further, the slits 121 are arranged in the length direction of the fuel channels 111. Here, as shown in FIG. 3, the slits 121 located relatively close to the fuel inlet 112 have a smaller width than the slits 121 located relatively far from the fuel inlet 112. That is to say, the widths of the slits 121 are gradually increased in a direction from the fuel inlet 112 to the fuel outlet 113.

Referring again to FIGS. 3 and 6, in some embodiments, the width a1 of first slits 121a located relatively close to the fuel inlet 112 is smaller than the width a3 of second slits 121b located relatively close to the fuel outlet 113. Further, the width a1 of the first slits 121a is smaller than the width a2 of third slits 121c located between the first slits 121a and the second slits 121b. In addition, the width a3 of the second slits 121b is greater than the width a2 of the third slits 121c. Here, the first slits 121a have the same width a1, and the second slits 121b have the same width a3. Further, the third slits 121c have the same width a2.

Like this, at least two of the slits 121 may have different widths, and some of the slits 121 may have the same width. Further, although not shown in the drawings, in another embodiment, all the slits 121 may have different widths. Here, the widths of the slits 121 extend in the length direction of the fuel channels 111. Further, the slits 121 are disposed parallel to one another.

The fuel supply control plate 120 having the slits 121 uniformly disperses the fuel passing through the fuel channels 111 through the slits 121 so as to transmit the fuel to the solid oxide cell 210. Referring to FIG. 7B, since the widths of the slits 121 of the fuel supply control plate 120 are gradually increased as the slits 121 are closer to the fuel outlet 113, the slits 121 limit the flow of the fuel flowing in the fuel channels 111 in the vertical direction, and thus make the flow rate of the fuel supplied to the solid oxide cell 210 uniform. Here, the flow of the fuel in the vertical direction is the flow of the fuel in the stacking direction of the separator 110 and the fuel supply control plate 120. That is, the flow of the fuel in the vertical direction is the flow of the fuel in a direction from the fuel channels 111 of the separator 110 to the fuel supply control plate 120.

The fuel supply control plate 120 uniformly controls the mass flux of the fuel supplied to the solid oxide cell 210 per unit area, and thereby, improves steam partial pressure deviations among electrochemical active reaction sites of the solid oxide cell 210 so as to make uniform reversible voltage of the solid oxide cell 210.

Further, in some embodiments, as shown in FIG. 6, the distances between the slits 121 are gradually decreased in the direction from the fuel inlet 111 to the fuel outlet 113. That is, the distances between the slits 121 are increased as the slits 121 are closer to the fuel inlet 112, and are decreased as the slits 121 are closer to the fuel outlet 113. Here, the distances between the slits 121 indicate the distances between the slits 121 closest to each other among the slits 121. That is, at least two of the distances between the slits 121 may have different values, and some of the distances between the slits 121 may have the same value.

Referring again to FIG. 6, in some embodiments, the distance between the first slits 121a located close to the fuel inlet 112 has a value b1, the distance between the second slits 121b located close to the fuel outlet 113 has a value b3, and the distance between the third slits 121c located between the fuel inlet 112 and the fuel outlet 113 has a value of b2. Further, the distance b1 between the first slits 121a located close to the fuel inlet 112 is greater than the distance b3 between the second slits 121b located close to the fuel outlet 113, and is greater than the distance b2 between the third slits 121c located between the fuel inlet 112 and the fuel outlet 113. Moreover, the distance b3 is smaller than the distance b2.

Further, although not shown in the drawings, in another embodiment, all the distances between the slits 121 may be different. In addition, the slits 121 may have the same length. The length of the slits 121 extend in the arrangement direction of the fuel channels 111.

The fuel supply control plate 120 has the slits 121 having the above-descried characteristics, and may thus more uniformly control the flow rate of the fuel supplied to the solid oxide cell 210. That is, the fuel supply control plate 120 reduces the distance between the second slits 121b disposed close to the fuel outlet 113 having a relatively low flow rate of the fuel compared to the fuel inlet 112, and thus minimizes reduction in the flow rate of the fuel transmitted to the solid oxide cell 210 from the fuel channels 111 at the downstream part of a fuel path.

Referring to FIGS. 3 and 4, the fuel channels 111 and the slits 121 are orthogonal to each other due to stacking of the fuel supply control plate 120 on the separator 110, and thereby, the fuel flowing into the fuel channels 111 is supplied to the solid oxide cell 210 through sections in which the fuel channels 111 and the slits 121 overlap each other.

FIG. 7A illustrates the state in which fuel is supplied to a general electrochemical cell, to which the fuel supply control plate according to one embodiment of the present disclosure is not applied, and FIG. 7B illustrates the state in which fuel is supplied to an electrochemical cell, to which the fuel supply control plate according to one embodiment of the present disclosure is applied. Although, in order to represent the flow rates of the fuel supplied to the solid oxide cell 210 by arrows, FIGS. 7A and 7B illustrate the solid oxide cell 210, the fuel supply control plate 120, and the separator 110, which are separated from one another, the fuel supply control plate 120 is actually stacked between the solid oxide cell 210 and the separator 110. Further, in FIGS. 7A and 7B, the arrows indicated by the solid line represent the flow of the fuel in the fuel inlet 112, the fuel outlet 113 and the fuel channels 111, and arrows indicated by a dotted line represent the flow rates of the fuel flowing from the fuel channels 111 to the solid oxide cell 210 (with reference to FIG. 7A) and the flow rates of the fuel flowing from the fuel channels 111 to the solid oxide cell 210 through the fuel supply control plate 120 (with reference to FIG. 7B). More concretely, the lengths of the arrows indicated by the dotted line in FIGS. 7A and 7B represent the relative flow rates of the fuel.

As shown in FIG. 7A, in the case in which the fuel supply control plate 120 is not disposed between the solid oxide cell 210 and the separator 110, as the fuel flowing into the fuel channels 111 through the fuel inlet 112 flows towards the fuel outlet 113, the mass flux of the fuel supplied to the solid oxide cell 210 per unit area is reduced. Because, as the fuel flowing into the fuel channels 111 is first supplied to the solid oxide cell 210 from the fuel channels 111 disposed at the upstream part of the fuel path and is thus consumed, the flow rates of the fuel supplied to the solid oxide cell 210 from the fuel channels 111 disposed at the midstream part and the downstream part of the fuel path are reduced. As the flow rates of the fuel supplied to the solid oxide cell 210 from the fuel channels 111 disposed at the midstream part and the downstream part of the fuel path are relatively reduced, the electrochemical reactions of the solid oxide cell 210 are gradually reduced, and consequently, reaction deviations of the solid oxide cell 210 occur in the flow direction of the fuel along the fuel channels 111.

On the other hand, as shown in FIG. 7B, in the case in which the fuel supply control plate 120 is disposed between the solid oxide cell 210 and the separator 110, the flow rate supplied to the solid oxide cell 210 from the fuel channels 111 disposed at the upstream part of the fuel path is relatively reduced. Thereby, the flow rates of the fuel supplied to the solid oxide cell 210 from the fuel channels 111 disposed at the midstream part and the downstream part of the fuel path are increased, the flow rates of the fuel supplied to all the active reaction sites of the solid oxide cell 210 are made uniform, and consequently, electrochemical reactions uniformly occur at the reaction interfaces of the solid oxide cell 210 as a whole.

As shown by the arrows indicated by the dotted line in FIG. 7B, the flow rates of the fuel flowing from the fuel channels 111 to the fuel supply control plate 120 are gradually reduced in the length direction of the fuel channels 111, but the flow rates of the fuel supplied to the solid oxide cell 210 through the slits 121 of the fuel supply control plate are made uniform.

An electrochemical cell 200 on which the fuel supply control plate 120 is mounted may have a sectional structure shown in FIG. 8.

As shown in FIG. 8, the electrochemical cell 200 includes a solid oxide cell 210, a pair of separators 110 and 300 stacked on both surfaces of the solid oxide cell 210, and the fuel supply control plate 120 stacked between the solid oxide cell 210 and the separator 110.

The solid oxide cell 210 includes a fuel electrode 211, an air electrode 212, and an electrolyte membrane 213 stacked between the fuel electrode 211 and the air electrode 212. The fuel supply control plate 120 is disposed adjacent to the fuel electrode 211. Here, the fuel supply control plate 120 is stacked between the second separator 110 and the fuel electrode 211. The first separator 300 may be formed to have the same structure as the second separator 110. The first separator 300 is disposed such that fuel channels 310 thereof are orthogonal to the fuel channels 111 of the second separator 110.

Referring to FIGS. 6, 7A, and 7B, the fuel supply control plate 120 has a first opening 123 and a second opening 124. The first opening 123 and the second opening 124 are located at designated positions of the fuel supply control plate 120 which face the fuel inlet 112 and the fuel outlet 113 of the separator 110. The first opening 123 and the second opening 124 are located on the fuel inlet 112 and the fuel outlet 113 to overlap the fuel inlet 112 and the fuel outlet 113, when the fuel supply control plate 120 is stacked between the solid oxide cell 210 and the separator 110.

Accordingly, in order to prevent the fuel from flowing towards the solid oxide cell 210 through the first opening 123 and the second opening 124, a sealing film 214 is formed on one surface of the solid oxide cell 210. The sealing film 214 may hermetically seal the openings 123 and 124 so as to prevent the flow of the fuel through the openings 123 and 124.

The fuel supply control plate 120 uniformly disperses the fuel flowing from the fuel channels 111 of the separator 110, and supplies the fuel to the solid oxide cell 210. Here, the fuel is supplied to the fuel electrode 211 of the solid oxide cell 210. As shown by arrows indicated by a dotted line in FIG. 8, the fuel is uniformly supplied to all active reaction sites of the fuel electrode 211, and thereby, the distribution of electrochemical reactions at the reaction interface between the fuel electrode 211 and the electrolyte membrane 213 is made uniform.

When the fuel is supplied to the fuel electrode 211, steam in the fuel is decomposed into oxygen ions and hydrogen by supplied power, and the oxygen ions migrate to the air electrode 212 through the electrolyte membrane 213. The oxygen ions are combined with electrons at the air electrode 212 so as to produce oxygen, and the oxygen is discharged.

As is apparent from the above description, the present disclosure provides a fuel supply control apparatus of an electrochemical cell, which may uniformly distribute fuel supplied to all active reaction sites of a solid oxide cell, and may thus induce uniform electrochemical reactions throughout all regions of the solid oxide cell so as to minimize reaction deviations among the active reaction sites of the solid oxide cell and to secure stability and performance of the electrochemical cell.

The disclosure has been described in detail with reference to exemplary embodiments thereof. However, it will be appreciated by those skilled in the art that changes may be made in these embodiments without departing from the principles and spirit of the disclosure, the scope of which is defined in the appended claims and their equivalents.

1. A fuel supply control apparatus of an electrochemical cell comprising a solid oxide cell and a separator stacked on the solid oxide cell, the fuel supply control apparatus comprising:
the separator having a fuel inlet, a fuel outlet, and a plurality of fuel channels arranged between the fuel inlet and the fuel outlet; and
a fuel supply control plate stacked between the separator and the solid oxide cell, the fuel supply control plate being configured to uniformly distribute and supply fuel flowing into the fuel channels to the solid oxide cell;
wherein the fuel supply control plate has a plurality of slits extending in a direction orthogonal to the fuel channels, and arranged in a length direction of the fuel channels.

2. The fuel supply control apparatus of claim 1, wherein the plurality of slits comprises a plurality of first slits located near the fuel inlet and a plurality of second slits located far from the fuel inlet than the plurality of first slits, wherein the plurality of first slits have a smaller width than the plurality of second slits.

3. The fuel supply control apparatus of claim 2, wherein at least two of the plurality of slits have different widths.

4. The fuel supply control apparatus of claim 1, wherein distances between each of the plurality of slits are gradually decreased in a direction from the fuel inlet to the fuel outlet.

5. The fuel supply control apparatus of claim 4, wherein at least two of the distances between the plurality of slits are different, and the distances between the plurality of slits are distances between slits closest to each other among the plurality of slits.

6. The fuel supply control apparatus of claim 1, wherein the each of the plurality of slits extends in an arrangement direction of the fuel channels, and wherein each of the plurality of slits extends to positions facing fuel channels disposed at outermost positions among the fuel channels.

7. The fuel supply control apparatus of claim 6, wherein each of the plurality of slits have an equal length.

8. The fuel supply control apparatus of claim 1, wherein the fuel channels are arranged in a row between the fuel inlet and the fuel outlet, and wherein the fuel channels extend in a direction orthogonal to a length direction of the fuel inlet and the fuel outlet.

9. A fuel supply control apparatus of an electrochemical cell comprising a solid oxide cell and a separator stacked on the solid oxide cell, the fuel supply control apparatus comprising:
the separator having a fuel inlet, a fuel outlet, and a plurality of fuel channels arranged between the fuel inlet and the fuel outlet; and
a fuel supply control plate having a plurality of slits arranged in a length direction of the fuel channels, and stacked between the separator and the solid oxide cell;
wherein the plurality of slits are configured such that each of the plurality of slits located close to the fuel inlet have a smaller width than each of the plurality of slits located far from the fuel inlet than the plurality of first slits.

10. The fuel supply control apparatus of claim 9, wherein distances between each of the plurality of slits are gradually decreased in a direction from the fuel inlet to the fuel outlet.

11. The fuel supply control apparatus of claim 9, wherein at least two of the plurality of slits have different widths.

12. The fuel supply control apparatus of claim 10, wherein at least two of the distances between each of the plurality of slits are different, and the distances between each of the plurality of slits are distances between slits closest to each other among the plurality of slits.

13. The fuel supply control apparatus of claim 9, wherein the plurality of slits extends in an arrangement direction of the fuel channels, and extends to positions facing fuel channels disposed at outermost positions among the fuel channels.

14. The fuel supply control apparatus of claim 9, wherein the fuel channels are arranged in a row between the fuel inlet and the fuel outlet, and wherein the fuel channels extend in a direction orthogonal to a length direction of the fuel inlet and the fuel outlet.
